(19) United States
(12) Patent Application Publication
(10) Pub. No.: US 2020/0094532 A1
(43) Pub. Date: Mar. 26, 2020

(54) LAMINATES INCLUDING A FLAME RETARDANT NEEDLE PUNCH NONWOVEN AND METHODS OF MAKING AND USING THE SAME

(71) Applicant: Precision Fabrics Group, Inc., Greensboro, NC (US)

(72) Inventors: William Scott Kinlaw, Greensboro, NC (US); Zareh Mikaelian, High Point, NC (US)

(21) Appl. No.: 16/580,703

(22) Filed: Sep. 24, 2019

Related U.S. Application Data
(60) Provisional application No. 62/736,528, filed on Sep. 26, 2018.

(51) Int. Cl. B32B 23/08; B32B 27/36; B32B 7/12; B32B 23/10; D04H 3/011; D04H 3/013

(52) U.S. Cl. CPC B32B 23/08; B32B 27/36; B32B 7/12; B32B 23/10; B32B 2305/20; D04H 3/013; B32B 2307/3065; B32B 2479/00; B32B 2601/00; D04H 3/011

(57) ABSTRACT

Provided herein are laminates including a flame retardant needle punch nonwoven along with methods of making and using the same. In some embodiments, the laminate comprises a first nonwoven fabric layer that is a spun bond nonwoven layer comprising polypropylene fibers; a second nonwoven fabric layer that is a needle punch nonwoven layer comprising a flame retardant; and an adhesive, wherein the adhesive adheres the first and second nonwoven fabric layers together. The laminate may be used as a filler cloth and/or in manufacturing mattresses.

### STATEMENT OF PRIORITY

This application claims the benefit of U.S. Provisional Application No. 62/736,528, filed on Sep. 26, 2018, the disclosure of which is incorporated herein by reference in its entirety.

### FIELD

The present invention generally relates to laminates including a flame retardant needle punch nonwoven, such as, for example, those used as filler cloths and/or in manufacturing mattresses, and to methods of making and using the same.

### BACKGROUND

Filler cloths are typically a flame retardant nonwoven fabric sewn onto the bottom of a mattress for the purposes of preventing the spread of flames should a mattress (comprised of flammable components like fabric, lofty materials and foam) catch fire. The filler cloth is one component of a flame retardant system in the mattress industry to comply with 16 CFR 1632-33. To test the efficacy of a filler cloth, a mattress is burned to test compliance with this regulation.

Surrogate tests have been developed to simulate the results of the 16 CFR 1632-33 mattress burns while testing the candidate filler cloth alone. Filler cloths are tested using ASTM D7140 and compared relative to one another on the maximum temperature observed on the fabric during the 60 second exposure to the flame (with the lower temperature being better).

Current filler cloths obtain strength properties and flame retardant properties simultaneously using a single nonwoven layer. This approach often requires the incorporation of expensive high performance, flame retardant fibers (such as, e.g., para-aramid, modacrylic, inherently flame resistant or silica-modified viscose fibers) into the single nowoven layer to provide strength and burn properties simultaneously in a single barrier layer. Another approach for a single layer filler cloth is to increase the weight of conventional fibers to achieve pre-burn strength and burn properties. These single layer filler cloths can have inherent flame retardant fibers, be finished with chemistry in order to provide flame retardancy, or have a flame retardant coating.

### SUMMARY OF EXAMPLE EMBODIMENTS

One aspect of the present invention is directed to a laminate comprising a first nonwoven fabric layer that is a spun bond nonwoven layer comprising polypropylene fibers; a second nonwoven fabric layer that is a needle punch nonwoven layer comprising a flame retardant; and an adhesive, wherein the adhesive adheres the first and second nonwoven fabric layers together.

Another aspect of the present invention is directed to a method of manufacturing a laminate, the method comprising laminating together a first nonwoven fabric layer and a second nonwoven fabric layer, wherein the first nonwoven fabric layer is a spun bond nonwoven layer comprising polypropylene fibers and the second nonwoven fabric layer is a needle punch nonwoven layer comprising a flame retardant. In some embodiments, laminating the first nonwoven fabric layer and the second nonwoven fabric layer together comprises applying an adhesive onto a surface of the first nonwoven fabric layer and/or the second nonwoven fabric layer.

An additional aspect of the present invention is directed to a mattress comprising a laminate of the present invention.

Another aspect of the present invention includes the use of a laminate of the present invention in a mattress.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 illustrates a laminate according to example embodiments of the present invention.

### DESCRIPTION OF EXAMPLE EMBODIMENTS

The present invention will now be described more fully hereinafter. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

It will be understood that when an element or layer is referred to as being “on”, “attached to”, “connected to”, “coupled to”, “coupled with” or “contacting” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. It will be appreciated by those of skill in the art that a structure referred to as being “directly on,” “directly connected to, or “directly coupled to” another structure may partially or completely cover one or more surfaces of the other structure. It will also be appreciated by those of skill in the art that references to a structure or feature that is disposed “adjacent” another structure or feature may have portions that overlap or underlie the adjacent structure or feature.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measureable value may include any other range and/or individual value therein.

As used herein, “ASTM” refers to ASTM, International, 100 Barr Harbor Drive, P.O. Box C700, West Conschoken, Pa. 19428-2959 USA.

As used herein, the terms “increase” and “enhance” (and grammatical variants thereof) refer to an increase in the specified parameter of greater than about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more.

As used herein, the terms “reduce,” “reduces,” “reduced,” “reduction,” “inhibit,” and similar terms refer to a decrease in the specified parameter of at least about 5%, 10%, 15%, 20%, 25%, 30%, 35%, 40%, 45%, 50%, 55%, 60%, 65%, 70%, 75%, 80%, 85%, 90%, 95%, 97%, or 100%.

According to embodiments of the present invention provided are multilayered fabrics (also referred to interchangeably herein as “laminates”) comprising at least two fabric layers (e.g., 2, 3, 4, 5, 6, or more) that are laminated together. A laminate of the present invention may be used as a filler cloth. The laminate may be attached, such as, for example, sewn, stapled, and/or the like, to a mattress. The mattress may be any size (e.g., sized for a king bed, a queen bed, etc.) and/or may be any type of mattress. In some embodiments, a laminate of the present invention may be sewn in during a current mattress assembly operation and/or sewn in using a current manufacturing process. In some embodiments, a laminate of the present invention is used as a flame retardant or flame blocking barrier and/or filler cloth in mattress construction. According to some embodiments, provided is a mattress comprising a laminate of the present invention and the mattress complies with (i.e., passes) 16 CFR 1632-33.

A “fabric layer” as used herein refers to a single fabric layer, such as, for example, a single nonwoven fabric layer. A laminate of the present invention comprises at least two nonwoven fabric layers (e.g., 2, 3, 4, 5, 6, or more) that may be the same as or different than another fabric layer in the laminate. In some embodiments, a laminate of the present invention comprises a woven fabric layer. In some embodiments, a laminate of the present invention includes only two nonwoven fabric layers.

In some embodiments, a woven fabric layer may be present in a laminate of the present invention. Example woven fabrics that may be used include, but are not limited to, plain weaves, basket weaves, twill weaves, satin weaves, and/or fancy weaves including jacquard weaves and/or dobby weaves.

Example nonwoven fabric layers that may be used in a laminate of the present invention include, but are not limited to, spun melt fabrics, stitch bonded fabrics, needle punched fabrics, spun laced fabrics, spun bonded fabrics, thermal bonded fabrics, powder bonded fabrics, chemical bonded fabrics, wet laid fabrics, and/or air laid fabrics. In some embodiments, at least one fabric layer in a laminate of the present invention is a spun bond nonwoven layer. In some embodiments, at least one layer in a laminate of the present invention is a needle punch nonwoven layer. According to some embodiments, a laminate of the present invention comprises at least one needle punched nonwoven fabric layer and at least one spun bonded nonwoven fabric layer.

A nonwoven fabric layer that may be used in a laminate of the present invention may be mechanically treated and/or have undergone any suitable mechanical treatment, including, but not limited to, calendaring, creping, embossing, and/or stretching. In some embodiments, a nonwoven fabric layer that may be used in a laminate of the present invention may be and/or have been chemically treated for certain properties, such as, but not limited to, flame retardancy, oil, alcohol and/or water repellency, antistatic, antimicrobial, corrosion inhibition, color, opacity, dimensional stability, coefficient of friction, and/or the like. In some embodiments, a fabric layer of the present invention may have a three-dimensional pattern, such as, for example, a three-dimensional pattern that mimics the three-dimensional texture of a woven textile (e.g., hopsack, terrycloth or twill). In some embodiments, at least one nonwoven fabric layer in a laminate of the present invention is treated with a flame retardant, optionally wherein at least one needle punch nonwoven layer is treated with a flame retardant.

In some embodiments, a laminate of the present invention may comprise natural fibers or synthetic fibers. Examples of fibers include, but are not limited to, bamboo fibers, cotton fibers, flax fibers, hemp fibers, jute fibers, polylactic acid fibers, silk fibers, wool (e.g., alpaca, angora, cashmere, chiengora, guanaco, llama, mohair, pashmina, sheep and/or vicuña) fibers, acrylic fibers, glass fibers, lyocell fibers, melamine fibers, modacrylic fibers, polyacrylonitrile (e.g., oxidized polyacrylonitrile) fibers, polyamide (e.g., nylon and/or aramid) fibers, polyester fibers, polyimide fibers, polylactic acid fibers, polyolefin (e.g., polyethylene and/or polypropylene) fibers, polyvinyl acetate fibers, polyvinyl alcohol fibers, rayon fibers, viscose fibers, modified viscose (e.g., silica-modified viscose) fibers, zylon fibers, and/or bicomponent fibers (e.g., fibers comprising a copolymer and/or fibers comprising two or more polymers (e.g., polyester and polypropylene)). According to some embodiments, a laminate of the present invention is devoid of flame retardant fibers such as, e.g., para-aramid fibers, meta-aramid fibers, modacrylic fibers, silica-modified viscose fibers, oxidized polyacrylonitrile (OPAN) fibers, etc.

In some embodiments, at least one fabric layer in a laminate of the present invention comprises polypropylene fibers, optionally polypropylene fibers in an amount of about 90% or 95% to about 98%, 99%, or 100% based on the fibers present in the fabric layer (e.g., by weight of the fabric layer or number of fibers present in the fabric layer). In some embodiments, at least one fabric layer in a laminate of the present invention comprises polypropylene fibers in an amount of about 90%, 91%, 92%, 93%, 94%, 95%, 96%, 97%, 98%, 99%, or 100% based on the fibers present in the fabric layer. In some embodiments, at least one fabric layer in a laminate of the present invention comprises spun bond polypropylene fibers, optionally wherein the polypropylene fibers are present in an amount of about 90% or 95% to about 98%, 99%, or 100% based on the fibers present in the fabric layer.

In some embodiments, at least one fabric layer in a laminate of the present invention comprises cellulosic fibers (e.g., rayon, viscose, Tencel, cotton, jute, flax, and/or hemp fibers) and/or polyester fibers. Cellulosic fibers and/or polyester fibers may be present in a fabric layer in an amount of about 1% to about 100% based on the fibers present in the fabric layer (e.g., by weight of the fabric layer or number of fibers present in the fabric layer) or any range therein, such as, for example, about 1% to about 50%, about 40% to about 70%, about 60% to about 95%, or about 50% to about 100%. In some embodiments, a fabric layer may comprise cellulosic fibers (e.g., rayon fibers), polyester fibers, or blends thereof in an amount of about 1%, 5%, 10%, 15%, 20%, 25%, 30%, 35%, 40%, 45%, 50%, 55%, 60%, 65%, 70%, 75%, 80%, 85%, 90%, 95%, or 100% based on the fibers present in the fabric layer (e.g., by weight of the fabric layer or number of fibers present in the fabric layer). In some embodiments, at least one fabric layer in a laminate of the present invention comprises cellulosic fibers (e.g., rayon fibers) in an amount of about 35%, 40%, 45%, 50%, 55%, 60%, 65%, 70%, 75% 80%, 85%, 90%, 95% or 100% based on the fibers present in the fabric layer. In some embodiments, at least one fabric layer in a laminate of the present invention comprises polyester fibers in an amount of about 1%, 5%, 10%, 15%, 20%, 25%, 30%, 35%, 40%, 45%, or 50% based on the fibers present in the fabric layer. In some embodiments, at least one fabric layer in a laminate of the present invention comprises cellulosic fibers (e.g., rayon fibers) in an amount of about 35%, 40%, 45%, 50%, 55%, 60%, 65%, 70% or 75% to about 80%, 85%, 90%, 95% or 100% based on the fibers present in the fabric layer and polyester fibers in an amount of about 1%, 5%, 10%, 15%, 20%, or 25% to about 30%, 35%, 40%, 45%, or 50% based on the fibers present in the fabric layer. In some embodiments, at least one fabric layer in a laminate of the present invention comprises cellulosic fibers (e.g., rayon fibers and/or viscose fibers) in an amount of about 75% based on the fibers present in the fabric layer and polyester fibers in an amount of about 25% based on the fibers present in the fabric layer. In some embodiments, at least one fabric layer in a laminate of the present invention comprises needle punch cellulosic fibers (e.g., rayon fibers) and/or polyester fibers. In some embodiments, the cellulosic fibers comprise rayon fibers and/or viscose fibers.

A laminate of the present invention may comprise a spun bond nonwoven layer, optionally comprising polypropylene fibers. A spun bond nonwoven layer, optionally comprising polypropylene fibers, may have a basis weight in a range of about 0.5, 1, 1.5, or 2 ounces per square yard (osy) to about 2.5, 3, or 4 osy. In some embodiments, a spun bond nonwoven layer, optionally comprising polypropylene fibers, has a basis weight of about 0.5, 1, 1.5, 2, 2.5, 3, 3.5, or 4 osy.

A laminate of the present invention may comprise a needle punch nonwoven layer comprising a flame retardant and optionally comprising cellulosic (e.g., rayon) fibers and/or polyester fibers. A needle punch nonwoven layer comprising a flame retardant and optionally comprising cellulosic (e.g., rayon) fibers and/or polyester fibers may have a basis weight in a range of about 1, 1.5, 2, 2.5, 3, or 3.5 osy to about 4, 4.5, 5, 5.5, or 6 osy. In some embodiments, a needle punch nonwoven layer comprising a flame retardant and optionally comprising cellulosic (e.g., rayon) fibers and/or polyester fibers, has a basis weight in a range of about 1, 1.5, 2, 2.5, 3, 3.5, 4, 4.5, 5, 5.5, or 6 osy.

According to some embodiments, a laminate of the present invention comprises a spun bond nonwoven layer having a basis weight in a range of about 0.5, 1, 1.5, or 2 osy to about 2,5, 3, 3.5, or 4 osy and a needle punch nonwoven layer having a basis weight in a range of about 1, 1.5, 2, 2.5, 3, or 3.5 osy to about 4, 4.5, 5, 5.5, or 6 osy. A laminate of the present invention may have a basis weight in a range of about 2, 2.5, 3, 3.5, 4, 4.5, 5, 5.5, or 6 osy to about 6.5, 7, 7.5, 8, 8.5, 9, 9.5, or 10 osy. In some embodiments, a laminate of the present invention has a basis weight of about 1.5, 2, 2.5, 3, 3.5, 4, 4,5, 5, 5.5, 6, 6.5, 7, 7.5, 8, 8.5, 9, 9.5, or 10 osy.

A laminate of the present invention comprises an adhesive between at least two fabric layers of the laminate such as, e.g., between a spun bond nonwoven layer and a needle punch nonwoven layer. In some embodiments, the adhesive may be, for example, a flame resistant adhesive material, water-based adhesive, solvent-based adhesive, hot melt adhesive, powder adhesive, web adhesive, pressure sensitive adhesive, and/or film adhesive. In some embodiments, the adhesive may be an aqueous, solvent, hot melt, thermoplastic or thermoset adhesive. Example adhesives that may be used include, but are not limited to, polyesters, acrylates, acetates, polyamides, ethylene vinyl acetates (EVAs), ethyl methacrylates (EMAs), polyolefins, thermoplastic polyurethanes, and/or reactive moisture cure urethanes. In some embodiments, the adhesive is a hot melt adhesive such as, e.g., TECHNOMELT® 6650 commercially available from Henkel.

In some embodiments, an adhesive layer may be applied and/or formed when an adhesive is applied onto a surface of a fabric layer and/or laminate of the present invention. The adhesive layer may be substantially continuous or may be discontinuous and may cover at least about 5% and up to 100% of the surface as measured using microscopic examination of the coated surface. In some embodiments, an adhesive layer may be provided on a surface of a fabric layer and/or laminate of the present invention, and the adhesive layer may cover at least about 5%, 10%, 20%, 30%, 40%, 50%, 60%, 70%, 80%, 90%, 95% or more of the surface (e.g., up to 100% of the surface). One or more layers of an adhesive (e.g., 1, 2, 3, 4, 5, or more) may be applied onto a surface of a fabric layer and/or laminate of the present invention, which may provide one or more adhesive layers (e.g., 1, 2, 3, 4, 5, or more). In some embodiments, an adhesive is applied onto a surface of a fabric layer in a discontinuous pattern and/or an adhesive layer is discontinuous.

An adhesive may be applied to a surface using methods known to those of skill in the art. For example, an adhesive may be applied using gravure printing (e.g., aqueous or solvent base media), screen printing, knife over roll coating, spraying, transfer printing, adhesive web, gravure printing hot melt adhesive (e.g., thermoplastic polymer base pressure sensitive adhesive (PSA) or reactive thermoset base, e.g., moisture cure urethane), porous ,coat hot melt adhesive (e.g., thermoplastic polymer base PSA or reactive thermoset base, e.g., moisture cure urethane), slot coating (thermoplastic polymer base PSA or reactive thermoset base, e.g., moisture cure urethane), and/or powder sprinkling (via Schindler roll). In some embodiments, an adhesive is applied using a porous coat laminator. An adhesive may be applied onto a surface of a fabric layer and/or laminate of the present invention at a coat weight of about 2, 2.5, 3, 3.5, 4, 4.5, 5, 5.5, or 6 gsm to about 6.5, 7, 7.5, 8, 8.5, 9, 9.5 or 10 gsm. In some embodiments, an adhesive is applied onto a surface of a fabric layer and/or laminate of the present invention at a coat weight of about 2, 2.5, 3, 3.5, 4, 4.5, 5, 5.5, 6, 6.5, 7, 7.5, 8, 8.5, 9, 9.5 or 10 gsm. In some embodiments, an adhesive may be present in a laminate in an amount of about 2, 2.5, 3, 3.5, 4, 4.5, 5, 5.5, or 6 gsm to about 6.5, 7, 7.5, 8, 8.5, 9, 9.5 or 10 gsm. In some embodiments, an adhesive may be present in a laminate in an amount of about 2, 2.5, 3, 3.5, 4, 4.5, 5, 5.5, 6, 6.5, 7, 7.5, 8, 8.5, 9, 9.5 or 10 gsm.

In some embodiments, at least one fabric layer of a laminate of the present invention and/or at least one surface of a laminate of the present invention comprises a flame retardant. A flame retardant may be present in a laminate of the present invention in an amount of about 1%, 5%, 10%, or 15% to about 20%, 25%, 30%, 35%, or 40% by weight of the fabric layer and/or laminate. In some embodiments, a flame retardant may be present in a laminate of the present invention in an amount of about 1%, 5%, 10%, 15%, 20%, 25%, 30%, 35%, or 40% by weight of the fabric layer and/or laminate. In some embodiments, a flame retardant is present in a laminate in an amount of about 1% to about 40% by weight of the laminate.

In some embodiments, at least one fabric layer of a laminate of the present invention and/or at least one surface of a laminate of the present invention is treated with a finish comprising a flame retardant. In some embodiments, the finish may increase and/or provide the laminate with one or more properties such as, but not limited to, abrasion resistance, alcohol repellence, durability, elasticity, flame retardancy, flexible, oil repellency, soil and/or stain repellency, UV resistance, anti-microbial, anti-fungal, antistatic, anti-skid and/or water repellency compared to prior to application of the finish. For example, the finish may comprise one or more substances that impart antimicrobial and/or antifungal properties to the fabric layer and/or laminate. Similarly, the finish may comprise one or more substances (e.g., pigments) that impart color to the fabric layer and/or laminate. In some embodiments, the finish is predominantly or exclusively present on at least one surface of the laminate. In some embodiments, the finish is present throughout at least one fabric layer (e.g., the needle punch nonwoven layer).

In some embodiments, the finish comprises one or more flame retardant chemistries. Example flame retardants and/or flame retardant chemistries include, but are not limited to, flame retardant antimony compounds (e.g., antimony oxides), flame retardant boron compounds (e.g., ammonium borate, borax, boric acid, ethylammonium borate and/or zinc borate), flame retardant halogen compounds (e.g., ammonium bromide, ammonium chloride, brominated/chlorinated binders and/or brominated/chlorinated paraffin), flame retardant nitrogen compounds (e.g., urea, ammonium polyphosphate), flame retardant phosphorous compounds (e.g., ammonium phosphate salt, ammonium polyphosphate, ammonium sulphate, etc.), clays, graphite, aluminum trihydrate, inorganic materials (e.g., clay, silica, calcium, magnesium), and/or flame retardant sulfur compounds (e.g., ammonium sulfamate). In some such embodiments, the flame retardant comprises and/or the finish comprises phosphorous compounds, sulfur compounds, and/or nitrogen compounds. In some such embodiments, the flame retardant comprises and/or finish comprises ammonium phosphate and/or a salt thereof. In some embodiments, the finish comprises at least one flame retardant, at least one surfactant, and/or at least one pigment.

A finish may be applied onto a surface of a fabric layer and/or laminate of the present invention at a weight of about 5, 10, 15, 20, 25, or 30 gsm to about 35, 40, 45, 50, 55, or 60 gsm. In some embodiments, a finish is applied onto a surface of a fabric layer and/or laminate of the present invention at a weight of about 5, 10, 15, 20, 25, 30, 35, 40, 45, 50, 55, or 60 gsm. In some embodiments, finish may be present in a laminate in an amount of about 5, 10, 15, 20, 25, or 30 gsm to about 35, 40, 45, 50, 55, or 60 gsm. In some embodiments, a finish may be present in a laminate in an amount of about 5, 10, 15, 20, 25, 30, 35, 40, 45, 50, 55, or 60 gsm.

A finish and/or flame retardant may be applied to a fabric layer and/or laminate using any suitable means known in the art, including, but not limited to, coating, corona discharge, dipping, hot melt application, pad finishing, plasma finishing, printing, rotogravure, slot-die application, spraying and/or vacuum metallization. In some embodiments, one or more fabric layer(s) (e.g., one or more needle punch nonwoven layer(s)) is/are treated with a finish and/or flame retardant prior to its incorporation into a laminate. In some embodiments, one or more fabric layer(s) (e.g., one or more needle punch nonwoven layer(s)) is/are treated with a finish and/or flame retardant after it is incorporated into a laminate. In some embodiments, a finish and/or flame retardant is applied via pad finishing.

A laminate of the present invention may have a thickness in a range of about 0.025 inches to about 0.25 inches, such as, for example, about 0.04 inches to about 0.075 inches, about 0.1 inches to about 0.25 inches, or about 0.06 inches to about 0.125 inches. In some embodiments, the laminate may have a thickness of about 0.025, 0.03, 0.035, 0.04, 0.045, 0.05, 0.055, 0.06, 0.065, 0.07, 0.075, 0.08, 0.085, 0.09, 0.095, 0.1, 0.125, 0.15, 0.2, or 0.25 inches, or any range therein. In some embodiments, a laminate of the present invention may have a thickness suitable for sewing or stapling the laminate to a mattress.

At least one fabric layer of a laminate of the present invention is devoid of a flame retardant and devoid of flame retardant fibers (i.e., at least one fabric layer is not treated or finished with a flame retardant and does not comprise flame retardant fibers or a flame retardant). In some embodiments, a mattress comprises a laminate of the present invention and the fabric layer that is not facing the external surface of the mattress (i.e., the fabric layer closest to the frame of the mattress) is devoid of a flame retardant and devoid of flame retardant fibers. Thus, in some embodiments, the fabric layer devoid of a flame retardant and devoid of flame retardant fibers (e.g., a non-FR SBPP layer) faces the frame of a mattress (i.e., the fabric layer devoid of a flame retardant and devoid of flame retardant fibers faces inward/internally to the mattress). In some embodiments, the spun bond nonwoven layer, optionally comprising polypropylene fibers, of a laminate of the present invention is devoid of a flame retardant and devoid of flame retardant fibers.

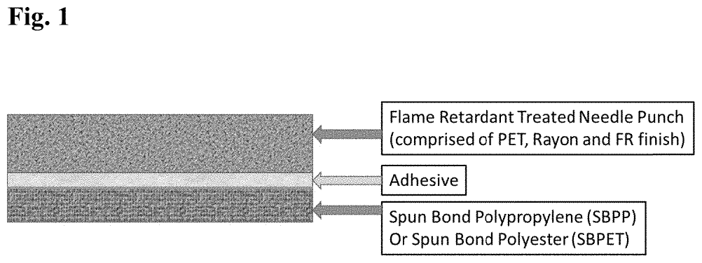

FIG. 1 shows a schematic of a side perspective view of an example laminate of the present invention comprising a flame retardant treated needle punch nonwoven layer comprising polyester fibers and rayon fibers that is adhesively laminated to a spun bond polypropylene or spun bond polyester nonwoven layer.

A spun bond nonwoven layer comprising polypropylene fibers may provide tensile, tear and/or seam-tear strength to a laminate, but does not provide flame retardancy and/or burn properties to the laminate. The inventors of the present invention discovered that by providing a laminate with a spun bond nonwoven layer comprising polypropylene fibers and a needle punch nonwoven layer comprising a flame retardant, the “pre-burn” strength properties can be separated from the flame-retardant properties. In addition, the inventors discovered that by addressing these two different properties (e.g., strength and flame retardancy) independently with separate nonwoven layers, one can use spun bond polypropylene (SBPP) and/or spun bond polyester (SBPET) layers to enhance strength, to eliminate and/or reduce the use of expensive flame retardant fibers, and/or to increase weight for the purpose of the laminate's preburn strength (tensile, tear, etc.) properties.

One skilled in the art of filler cloth design would assume that adhesively laminating a SBPP to a flame retardant filler cloth barrier (“barrier”) would diminish the burn properties of the barrier since the SBPP fabric and adhesive to adhere the SBPP to FRNP (Flame Retardant Needle Punch fabric) would provide additional fuel and increase the intensity and duration of the burn. In contrast, the inventors of the present invention discovered that laminates of the present invention can provide sufficient pre-burn strength properties, and provide improved burn performance as measured in accordance with ASTM D7140, despite not having high performance flame retardant fibers and/or unnecessary, additional finished flame retardant fibers.

According to some embodiments, a laminate of the present invention may have a tensile strength in a range of about 15, 20, 25, or 30 lbs to about 35, 40, 45, 50, 55, 60, 65, 70, 75, 80, 85, 90, 95, 100 lbs, or more as measured in the machine direction (MD) and/or cross machine direction (XD) in accordance with ASTM D5034. In some embodiments, a laminate of the present invention may have a tensile strength of about 15, 20, 25, 30, 35, 40, 45, 50, 55, 60, 65, 70, 75, 80, 85, 90, 95, 100 lbs, or more as measured in the MD and/or XD in accordance with ASTM D5034.

In some embodiments, a laminate of the present invention may have a trap tear in a range of about 1, 5, 10, 15, or 20 lbs to about 25, 30, 35, 40, 45, 50, 55, 60, 65, 70, 75, 80, 85, 90, 95, 100 lbs, or more as measured in the MD and/or XD in accordance with ASTM D5733. In some embodiments, a laminate of the present invention may have a trap tear of about 1, 5, 10, 15, 20, 25, 30, 35, 40, 45, 50, 55, 60, 65, 70, 75, 80, 85, 90, 95, 100 lbs, or more as measured in the MD and/or XD in accordance with ASTM D5733.

In some embodiments, a laminate of the present invention has a maximum temperature of about 350° F. or less within about 60 seconds when measured in accordance with ASTM D7140. In some embodiments, the maximum temperature is about 350° F., 349° F., 348° F., 347° F., 346° F., 345° F., 344° F., 343° F., 342° F., 341° F., 340° F., 339° F., 338° F., 337° F., 336° F., 335° F., 334° F., 333° F., 332° F., 331° F., 330° F., 329° F., 328° F., 327° F., 326° F., 325° F., or less.

Provided according to some embodiments is a method of manufacturing a laminate, the method comprising laminating together a first nonwoven fabric layer and a second nonwoven fabric layer. In some embodiments, the first nonwoven fabric layer is a spun bond nonwoven layer comprising polypropylene fibers and the second nonwoven fabric layer is a needle punch nonwoven layer comprising a flame retardant. A surface of the first nonwoven fabric layer is laminated to a surface of the second nonwoven fabric layer using an adhesive. In some embodiments, the only element between the first nonwoven fabric layer and the second nonwoven fabric layer is an adhesive, which may be continuous or discontinuous. In some embodiments, the adhesive is discontinuous and at least a portion of a surface of the first nonwoven fabric layer is in contact with at least a portion of a surface of the second nonwoven fabric layer and/or is in close proximity to, with no intervening elements, at least a portion of a surface of the second nonwoven fabric layer.

Adhesively laminating a spun bond nonwoven fabric layer comprising polypropylene fibers (spun-bond polypropylene fabric or “SBPP”) to another nonwoven fabric layer (e.g., a needle punch nonwoven layer comprising a flame retardant) can provide superior properties compared to needling or stitching the SBPP to the other nonwoven fabric layer. Adhesive lamination can allow the SBPP, when exposed to flame, to melt, shrink, and pull away from the flame area as the adhesive softens. This can minimize the fuel as the SBPP has pulled away from the other fabric layer (e.g., the needle punch nonwoven layer comprising a flame retardant) and can particularly provide superior properties when the other nonwoven fabric layer comprises a flame retardant since it is not available to burn and further compromise the laminate.

In some embodiments, laminating the first nonwoven fabric layer and the second nonwoven fabric layer together comprises applying an adhesive onto a surface of the first nonwoven fabric layer and/or the second nonwoven fabric layer as described herein. In some embodiments, a method of the present invention comprising applying a flame retardant and/or a finish to a surface of a fabric layer and/or a laminate as described herein.

The foregoing and other aspects of the invention are explained further in the following examples.

### EXAMPLES

### Example 1

Laminates were prepared and tested using ASTM D7140 to determine the maximum temperature observed on the fabric during the 60 second exposure to the flame (with the lower temperature being better). A flame retardant needle punch/spun bond polypropylene (FRNP/SBPP) laminate, a flame retardant needle punch/spun bond polyester (FRNP/SBPET) laminate , and a commonly-used laminated filler cloth, which is referred to herein as HPFN were provided. For the FRNP/SBPP laminate, the FRNP layer had a finished weight of approximately 3.8 osy and included 13% ammonium phosphate salt and 87% fiber (75% rayon, 25% PET), the SBPP layer was approximately 2.0 osy of 100% polypropylene, and 0.2 osy of adhesive was used to laminate the two layers together. For the FRNP/SBPET laminate, the FRNP layer had a finished weight of approximately 3.8 osy and included 13% ammonium phosphate salt and 87% fiber (75% rayon, 25% PET), the SBPET layer was approximately 2.0 osy of 100% PET, and 0.2 osy of adhesive was used to laminate the two layers together. HPFN is a high performance fiber nonwoven filler cloth and is a laminate of 2.3 osy spun bond PET (SBPET) laminated to 1.8 osy nowoven bonded web made of 50% silica modified viscose fibers, 25% P-aramid (both high performance flame retardant fibers) and 25% polyester. The results from the standard horizontal burn testing in accordance with ASTM D7140, as measured during the 60 second exposure to the flame, are provided in Table 1.

TABLE 1
Burn Testing Results

| | | FRNP/ | FRNP/ | |
|---|---|---|---|---|
| | | SBPP | SBPET | |
| | Units | Laminate | Laminate | HPFN |
| Basis Weight | osy | 5.97 | 5.97 | 4.1 |
| Max Temp (IR Sensor) | Degree F | 331 | 338 | 395 |

These results show that the FRNP/SBPP laminate has better performance in the most relevant property desired for filler cloth application. Surprisingly, it performs better than a similar laminate with SBPET as the sacrificial layer despite the base polymer of SBPET (i.e., polyester (PET)) having superior burn properties than the base polymer of SBPP (i.e., polypropylene (PP)).

PET has a higher melt temperature than PP (250-264° C. compared to 130-179° C.). It also has a higher LOI (limiting oxygen index) than PP (24-25% vs. 17-18%). The limiting oxygen index is the minimum concentration of oxygen, expressed as a percentage in the surrounding gas, that will support combustion of a polymer. It is measured using ASTM D2863 and is an accepted measure of the relative flame resistance of a polymer.

Given these inferior thermal properties of the PP polymer (which would be translated to the SBPP nonwoven), it was surprising that a laminate containing SBPP would perform better than a comparable SBPET laminate. Further, the SBPP-containing laminate performs better than HPFN, which is also surprising since HPFN contains fibers specifically designed for flame retardancy that are used extensively in mattress filler cloth applications. In addition, the basis weight for FRNP/SBPP is higher (which provides more pre-burn strength and fuel) than the basis weight of HPFN.

Even though the basis weight is higher for FRNP/SBPP, the FRNP/SBPP laminate has the advantage of being significantly less expensive than HPFN containing high performance fibers. Further, SBPP is significantly less expensive than SBPET making the FRNP/SBPP laminate less expensive than the FRNP/SBPET laminate.

The foregoing is illustrative of the present invention, and is not to be construed as limiting thereof. The invention is defined by the following claims, with equivalents of the claims to be included therein. All publications, patent applications, patents, patent publications, and other references cited herein are incorporated by reference in their entireties for the teachings relevant to the sentence and/or paragraph in which the reference is presented.

That which is claimed is:

1. A laminate comprising
a first nonwoven fabric layer that is a spun bond nonwoven layer comprising polypropylene fibers;
a second nonwoven fabric layer that is a needle punch nonwoven layer comprising a flame retardant; and
an adhesive, wherein the adhesive adheres the first and second nonwoven fabric layers together.

2. The laminate of claim 1, wherein the second nonwoven fabric layer comprises rayon fibers and/or polyester fibers.

3. The laminate of claim 1, wherein the first nonwoven fabric layer has a basis weight in a range of about 0.5 or 1 ounces per square yard (osy) to about 3 or 4 osy.

4. The laminate of claim 1, wherein the second nonwoven fabric layer has a basis weight in a range of about 1 or 2 osy to about 5 or 6 osy.

5. The laminate of claim 1, wherein the laminate is devoid of flame retardant fibers.

6. The laminate of claim 1, wherein the first nonwoven layer comprises polypropylene fibers in an amount of about 90% to about 100% by weight of the first nonwoven layer, optionally wherein the first nonwoven layer consists of spun bond polypropylene fibers.

7. The laminate of claim 1, wherein the second nonwoven layer comprises cellulosic fibers and polyester fibers in an amount of about 50% to about 100% by weight of the second nonwoven fabric layer, optionally wherein the second nonwoven layer comprises fibers and the fibers consist of cellulosic fibers and polyester fibers.

8. The laminate of claim 1, wherein the second nonwoven layer comprises cellulosic fibers and polyester bicomponent fibers in an amount of about 50% to about 100% by weight of the second nonwoven fabric layer, optionally wherein the second nonwoven layer comprises fibers and the fibers consist of cellulosic fibers and polyester bicomponent fibers.

9. The laminate of claim 1, wherein the laminate has a thickness in a range of about 0.025 to about 0.25 inches.

10. The laminate of claim 1, wherein the first nonwoven layer is devoid of a flame retardant and flame retardant fibers.

11. The laminate of claim 1, wherein the laminate has a tensile strength of at least about 30 lbs as measured in the machine direction (MD) and/or cross machine direction (XD) in accordance with ASTM D5034 and/or a trap tear of about least about 5 lbs as measured in MD and/or XD in accordance with ASTM D5733.

12. The laminate of claim 1, wherein the laminate has a maximum temperature of about 335° F. or less within about 60 seconds when measured in accordance with ASTM D7140.

13. The laminate of claim 1, wherein the laminate has a basis weight in a range of about 1.5 osy to about 10 osy.

14. A mattress comprising the laminate of claim 1.

15. The laminate of claim 1 for use in a mattress.

16. The mattress of claim 14, wherein the mattress complies with 16 CFR 1632-33.

17. A method of manufacturing a laminate, the method comprising:
laminating together a first nonwoven fabric layer and a second nonwoven fabric layer using an adhesive,
wherein the first nonwoven fabric layer is a spun bond nonwoven layer comprising polypropylene fibers and the second nonwoven fabric layer is a needle punch nonwoven layer comprising a flame retardant.

18. The method of claim 17, wherein a surface of the first nonwoven fabric layer is laminated to a surface of the second nonwoven fabric layer.
